(19) United States
(12) Patent Application Publication
(10) Pub. No.: US 2025/0201260 A1
(43) Pub. Date: Jun. 19, 2025

(54) REPRESENTATION LEARNING USING INFORMED MASKING FOR SPEECH AND OTHER AUDIO APPLICATIONS

(71) Applicant: DOLBY LABORATORIES LICENSING CORPORATION, San Francisco, CA (US)

(72) Inventors: Paul Holmberg, North Ryde, NSW (AU); Hadis Nosrati, Queens Park, NSW (AU); Richard J. Cartwright, Killara, NSW (AU)

(73) Assignee: DOLBY LABORATORIES LICENSING CORPORATION, San Francisco, CA (US)

(21) Appl. No.: 18/851,467

(22) PCT Filed: Mar. 28, 2023
(86) PCT No.: PCT/US2023/016634

§ 371 Date: Sep. 26, 2024

Related U.S. Application Data
(60) Provisional application No. 63/325,127, filed on Mar. 29, 2022.
(60) Provisional application No. 63/490,212, filed on Mar. 14, 2023.

(51) Int. Cl. G10L 21/0232; G10L 25/30

(52) U.S. Cl. CPC G10L 21/0232; G10L 25/30

(57) ABSTRACT

Some disclosed methods involve receiving, by a control system configured to implement at least one neural network, input audio data and feature weightings and producing, by the control system and based at least in part on the input audio data and the feature weightings, latent space embeddings. In some examples, the input audio data corresponds to an input mathematical space and the latent space embeddings may correspond with unmasked portions of the input audio data. According to some examples, the latent space embeddings may be mathematical representations of the input audio data indicated by the feature weightings in a latent space that is a different mathematical space from the input mathematical space. In some examples, the feature weightings may be, or may be based on, mask data.

### CROSS-REFERENCE TO RELATED APPLICATIONS

This application claims priority to U.S. Provisional Application No. 63/325,127 filed Mar. 29, 2022, and U.S. Provisional Application No. 63/490,212 filed on Mar. 14, 2023, each of which is incorporated by reference in its entirety.

### TECHNICAL FIELD

This disclosure pertains to devices, systems and methods for representation learning, particularly speech representation learning (SRL).

### BACKGROUND

Some methods, devices and systems for SRL are known. Although existing devices, systems and methods for SRL can provide benefits in some contexts, improved devices, systems and methods would be desirable.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers) driven by a single speaker feed. A typical set of headphones includes two speakers. A speaker may be implemented to include multiple transducers (e.g., a woofer and a tweeter), which may be driven by a single, common speaker feed or multiple speaker feeds. In some examples, the speaker signal(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

Throughout this disclosure including in the claims, the term “couples” or “coupled” is used to mean either a direct or indirect connection. Thus, if a first device couples to a second device, that connection may be through a direct connection, or through an indirect connection via other devices and connections.

As used herein, a “smart device” is an electronic device, generally configured for communication with one or more other devices (or networks) via various wireless protocols such as Bluetooth, Zigbee, near-field communication, Wi-Fi, light fidelity (Li-Fi), 3G, 4G, 5G, etc., that can operate to some extent interactively and/or autonomously. Several notable types of smart devices are smartphones, smart cars, smart thermostats, smart doorbells, smart locks, smart refrigerators, phablets and tablets, smartwatches, smart bands, smart key chains and smart audio devices. The term “smart device” may also refer to a device that exhibits some properties of ubiquitous computing, such as artificial intelligence.

Herein, we use the expression “smart audio device” to denote a smart device which is either a single-purpose audio device or a multi-purpose audio device (e.g., an audio device that implements at least some aspects of virtual assistant functionality). A single-purpose audio device is a device (e.g., a television (TV)) including or coupled to at least one microphone (and optionally also including or coupled to at least one speaker and/or at least one camera), and which is designed largely or primarily to achieve a single purpose. For example, although a TV typically can play (and is thought of as being capable of playing) audio from program material, in most instances a modern TV runs some operating system on which applications run locally, including the application of watching television. In this sense, a single-purpose audio device having speaker(s) and microphone(s) is often configured to run a local application and/or service to use the speaker(s) and microphone(s) directly. Some single-purpose audio devices may be configured to group together to achieve playing of audio over a zone or user configured area.

One common type of multi-purpose audio device is a smart audio device, such as a “smart speaker,” which may be configured to implement at least some aspects of virtual assistant functionality, although other aspects of virtual assistant functionality may be implemented by one or more other devices, such as one or more servers with which the multi-purpose audio device is configured for communication. Such a multi-purpose audio device may be referred to herein as a “virtual assistant.” A virtual assistant is a device (e.g., a smart speaker or voice assistant integrated device) including or coupled to at least one microphone (and optionally also including or coupled to at least one speaker and/or at least one camera). In some examples, a virtual assistant may provide an ability to utilize multiple devices (distinct from the virtual assistant) for applications that are in a sense cloud-enabled or otherwise not completely implemented in or on the virtual assistant itself. In other words, at least some aspects of virtual assistant functionality, e.g., speech recognition functionality, may be implemented (at least in part) by one or more servers or other devices with which a virtual assistant may communication via a network, such as the Internet. Virtual assistants may sometimes work together, e.g., in a discrete and conditionally defined way. For example, two or more virtual assistants may work together in the sense that one of them, e.g., the one which is most confident that it has heard a wakeword, responds to the wakeword. The connected virtual assistants may, in some implementations, form a sort of constellation, which may be managed by one main application which may be (or implement) a virtual assistant.

Herein, “wakeword” is used in a broad sense to denote any sound (e.g., a word uttered by a human, or some other sound), where a smart audio device is configured to awake in response to detection of (“hearing”) the sound (using at least one microphone included in or coupled to the smart audio device, or at least one other microphone). In this context, to “awake” denotes that the device enters a state in which it awaits (in other words, is listening for) a sound command. In some instances, what may be referred to herein as a “wakeword” may include more than one word, e.g., a phrase.

Herein, the expression “wakeword detector” denotes a device configured (or software that includes instructions for configuring a device) to search continuously for alignment between real-time sound (e.g., speech) features and a trained model. Typically, a wakeword event is triggered whenever it is determined by a wakeword detector that the probability that a wakeword has been detected exceeds a predefined threshold. For example, the threshold may be a predetermined threshold which is tuned to give a reasonable compromise between rates of false acceptance and false rejection. Following a wakeword event, a device might enter a state (which may be referred to as an “awakened” state or a state of “attentiveness”) in which it listens for a command and passes on a received command to a larger, more computationally-intensive recognizer.

As used herein, the terms “program stream” and “content stream” refer to a collection of one or more audio signals, and in some instances video signals, at least portions of which are meant to be heard together. Examples include a selection of music, a movie soundtrack, a movie, a television program, the audio portion of a television program, a podcast, a live voice call, a synthesized voice response from a smart assistant, etc. In some instances, the content stream may include multiple versions of at least a portion of the audio signals, e.g., the same dialogue in more than one language. In such instances, only one version of the audio data or portion thereof (e.g., a version corresponding to a single language) is intended to be reproduced at one time.

### SUMMARY

At least some aspects of the present disclosure may be implemented via one or more methods. In some instances, the method(s) may be implemented, at least in part, by a control system and/or via instructions (e.g., software) stored on one or more non-transitory media. Some disclosed methods involve receiving, by a control system configured to implement at least one neural network, input audio data and feature weightings. Some such methods may involve producing, by the control system and based at least in part on the input audio data and the feature weightings, latent space embeddings. In some examples, the input audio data may correspond to an input mathematical space and the latent space embeddings may be, or may include, mathematical representations of the input audio data indicated by the feature weightings in a latent space that is a different mathematical space from the input mathematical space. According to some examples, the input audio data may include audio signals corresponding to speech.

In some examples, the feature weightings may be, or may include mask data. According to some examples, the mask data may be derived from estimations of signal and noise in the input audio data. In some examples, the latent space embeddings may correspond with unmasked portions of the input audio data.

In some examples, the control system may be configured to implement a convolutional neural network configured to perform weighted convolution. In some such examples, the weighted convolution may be based, at least in part, on the feature weightings.

According to some examples, producing the latent space embeddings may involve applying, by the control system, a contextual encoding process. In some examples, the at least one neural network may have been trained to implement the contextual encoding process.

Some methods may involve applying, to the latent space embeddings and by the control system, a hidden representation process. The hidden representation process may produce a representation of the input audio data in the latent space. Some such methods may involve applying, by the control system, a contextual decoding process to the representation of the input audio data in the latent space, to produce a modified audio signal. Some methods may involve producing a residual signal based, at least in part, on the modified audio signal and a version of the input audio data. In some examples, the version of the input audio data may include frequency binned audio data. According to some examples, the modified audio signal may be in a frequency domain and wherein producing the residual signal may involve transforming a frequency domain version of the residual signal into a time domain. In some examples, the input audio data and the feature weightings may correspond to frequency bands.

According to some examples, the input audio data may have been pre-conditioned according to one or more audio data processing methods. In some such examples, the input audio data may have been pre-conditioned according to at least one of an echo cancellation process, an echo suppression process, a noise suppression process or a beamforming process.

In some examples, the at least one neural network may have also been trained to implement an attention-based masking process for producing embeddings. In some such examples, at least one of the attention-based masking process or a contextual encoding process may have been trained to recognize and to compensate for one or more errors in the masking process. In some examples, the at least one neural network may have been trained according to mask data and according to contaminated audio signals output from an audio augmentation process. According to some examples, the audio augmentation process may involve adding noise, adding reverberations, adding audio signals corresponding to speech or other interfering audio sources, or combinations thereof. In some examples, training the at least one neural network may involve modulating mask data parameters. According to some examples, training the at least one neural network may involve maintaining a constant target audio signal during one or more time intervals during which the mask data parameters are modulated.

In some examples, the control system may be configured for speech representation learning (SRL). In some such examples, the at least one neural network may include an SRL encoder. According to some examples, the SRL encoder may be, or may include, a convolutional encoder. In some examples, the convolutional encoder may include partial convolution layers.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via apparatus. For example, one or more devices (e.g., a system that includes one or more devices) may be capable of performing, at least in part, the methods disclosed herein. In some implementations, an apparatus is, or includes, an audio processing system having an interface system and a control system. The control system may include one or more general purpose single-or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. The control system may be configured for implementing some or all of the methods disclosed herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Like reference numbers and designations in the various drawings indicate like elements.

FIG. 1A is a block diagram that shows examples of components of an apparatus capable of implementing various aspects of this disclosure.

FIG. 1B shows an example of an audio signal enhancement chain.

FIG. 2 shows an alternative example of an audio signal enhancement chain according to some disclosed implementations.

FIG. 3 shows example blocks of a masquerade module according to some disclosed implementations.

FIG. 4 shows example blocks of a masquerade module according to some alternative implementations.

FIG. 5 shows example blocks of a process of training a masquerade module according to some implementations.

FIGS. 6A and 6B show example blocks of masquerade modules according to some alternative implementations.

FIG. 7 is a flow diagram that outlines one example of a disclosed method.

### DETAILED DESCRIPTION OF EMBODIMENTS

Using the voice as the user interface has become a convenient medium of communication between human and machines. However, the technologies that could provide a seamless experience for users in such human-machine interactions seem to be in their early stages of development.

The advent of machine learning (ML) and its advancement in areas such as audio processing—including but not limited to speech processing—has provided the opportunity to represent audio data in what is called a “latent space” in which the high-level attributes or distinct characteristics of audio signals can be derived automatically from the data. Representations in a latent space can be used to enable or improve a variety of use case applications, including but not limited to sound event classification, talker identification and automatic speech recognition.

Speech and audio representation learning, relying on self-supervised training, has proven to be effective in generating high-level information from input audio data, thereby capturing distinct attributes of the input audio data. Some such attributes may be domain-independent.

Contextual awareness has proven to be important at both the speech capture and decision-making stages to derive analytics for devices that implement automatic speech recognition and other speech-related functionality. Contextual speech representation learning (SRL)—in which high-level information and unique attributes of audio data are captured in an embedding space—can be used to infer information from the overall learned context. This can be particularly important if the input audio data corresponding to speech is masked or highly polluted by environmental artifacts such as noise, echo, other interfering voices, etc.

Generative SRL is a method of learning such distinct attributes of input audio data by finding the high-level representations that can be used to regenerate the signal again. In this approach, the input audio data, or input features extracted from the input audio data, are masked randomly and a neural network is trained to predict the high-level representations of these masked regions using the neighboring frames for context.

This disclosure provides examples of how using contextual generative SRL and feature weightings, a target audio signal—such as an audio signal corresponding to a user's speech—can be restored from a contaminated input audio signal. In some examples the feature weightings may be, or may include, mask data provided by use an echo canceller, noise suppressor or prior scene analysis. The mask data be derived from estimations of signal and noise in the input audio data. Therefore, the mask data may indicate which portions of the target signal are likely to be masked due to environmental artifacts and which portions of the target signal are likely to be intact and therefore include relatively more useful information. According to some examples, mask data may be used to distort the signal and contextual generative SRL may predict the audio content, with the goal being to recover the target signal.

Some disclosed implementations involve self-supervised learning techniques that combine prior knowledge of mask data with the SRL contextual power to create a desired target signal. The mask data may indicate which portions—such as which bins or bands—of the audio data are likely to be signals and which portions are likely to be noise.

Accordingly, some disclosed implementations may involve improving the quality of a generated audio signal. Alternatively, or additionally, some disclosed implementations may create SRL embeddings which do not represent undesired artifacts present in the input audio signals. Some such SRL embeddings may represent high-level attributes of the input audio data that are not affected by environmental and acoustic artifacts. SRL embeddings produced according to some disclosed methods can improve various learning tasks and downstream audio processing tasks, including but not limited to source separation, speech enhancement, speaker diarization, speech recognition, noise suppression, echo suppression and talker identification.

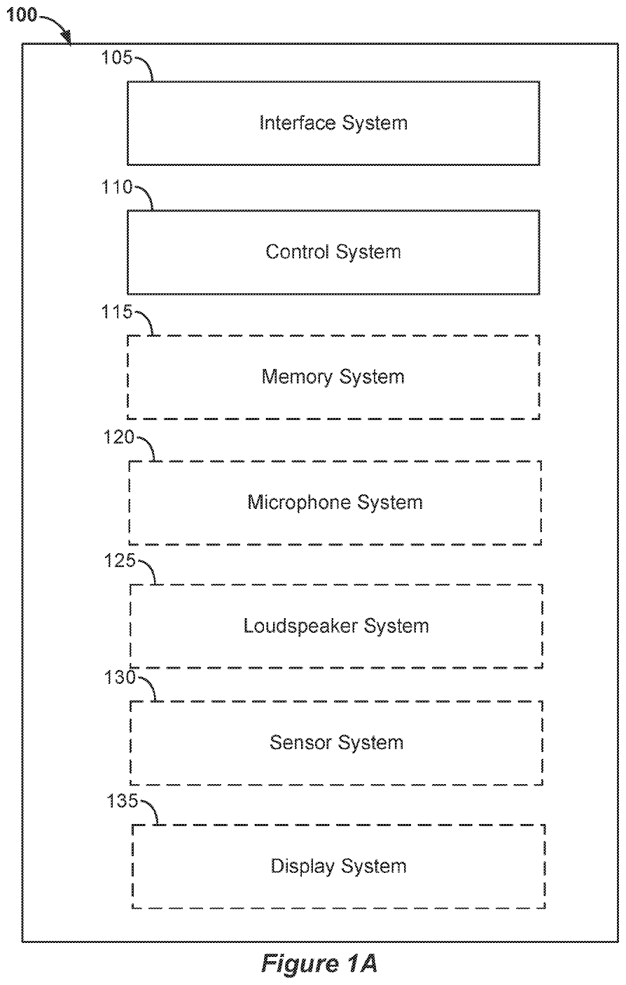

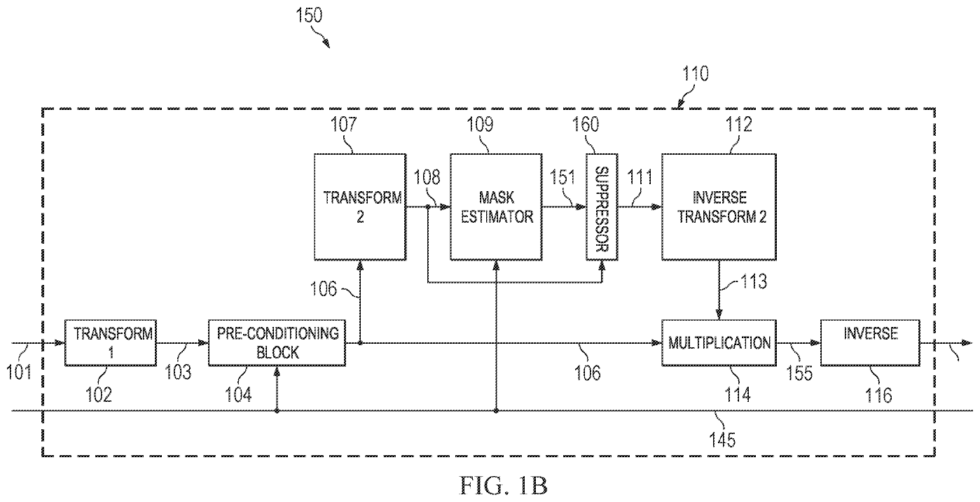

FIG. 1A is a block diagram that shows examples of components of an apparatus capable of implementing various aspects of this disclosure. As with other figures provided herein, the types, numbers and arrangements of elements shown in FIG. 1A are merely provided by way of example. Other implementations may include more, fewer and/or different types, numbers and arrangements of elements. According to some examples, the apparatus 100 may be configured for performing at least some of the methods disclosed herein. In some implementations, the apparatus 100 may be, or may include, one or more components of an office workstation, one or more components of a home entertainment system, etc. For example, the apparatus 100 may be a laptop computer, a tablet device, a mobile device (such as a cellular telephone), a smart home hub, a television or another type of device.

According to some alternative implementations the apparatus 100 may be, or may include, a server. In some such examples, the apparatus 100 may be, or may include, an encoder. In some examples, the apparatus 100 may be, or may include, a decoder. Accordingly, in some instances the apparatus 100 may be a device that is configured for use within an environment, such as a home environment, whereas in other instances the apparatus 100 may be a device that is configured for use in “the cloud,” e.g., a server.

In this example, the apparatus 100 includes an interface system 105 and a control system 110. The interface system 105 may, in some implementations, be configured for communication with one or more other devices of an environment. The environment may, in some examples, be a home environment. In other examples, the environment may be another type of environment, such as an office environment, an automobile environment, a train environment, a street or sidewalk environment, a park environment, etc. The interface system 105 may, in some implementations, be configured for exchanging control information and associated data with other devices of the environment. The control information and associated data may, in some examples, pertain to one or more software applications that the apparatus 100 is executing.

The interface system 105 may, in some implementations, be configured for receiving, or for providing, a content stream. In some examples, the content stream may include video data and audio data corresponding to the video data. The audio data may include, but may not be limited to, audio signals. In some instances, the audio data may include spatial data, such as channel data and/or spatial metadata. Metadata may, for example, have been provided by what may be referred to herein as an “encoder.”

The interface system 105 may include one or more network interfaces and/or one or more external device interfaces (such as one or more universal serial bus (USB) interfaces). According to some implementations, the interface system 105 may include one or more wireless interfaces. The interface system 105 may include one or more devices for implementing a user interface, such as one or more microphones, one or more speakers, a display system, a touch sensor system, a gesture sensor system, or combinations thereof. Accordingly, while some such devices are represented separately in FIG. 1A, such devices may, in some examples, correspond with aspects of the interface system 105.

In some examples, the interface system 105 may include one or more interfaces between the control system 110 and a memory system, such as the optional memory system 115 shown in FIG. 1A. Alternatively, or additionally, the control system 110 may include a memory system in some instances. The interface system 105 may, in some implementations, be configured for receiving input from one or more microphones in an environment.

The control system 110 may, for example, include a general purpose single-or multi-chip processor, a digital signal processor (DSP), an application specific integrated circuit (ASIC), a field programmable gate array (FPGA) or other programmable logic device, discrete gate or transistor logic, discrete hardware components, or combinations thereof.

In some implementations, the control system 110 may reside in more than one device. For example, in some implementations a portion of the control system 110 may reside in a device within one of the environments referred to herein and another portion of the control system 110 may reside in a device that is outside the environment, such as a server, a mobile device (such as a smartphone or a tablet computer), etc. In other examples, a portion of the control system 110 may reside in a device within one of the environments depicted herein and another portion of the control system 110 may reside in one or more other devices of the environment. For example, control system functionality may be shared by an orchestrating device (such as what may be referred to herein as a smart home hub) and one or more other devices of the environment. In other examples, a portion of the control system 110 may reside in a device that is implementing a cloud-based service, such as a server, and another portion of the control system 110 may reside in another device that is implementing the cloud-based service, such as another server, a memory device, etc. The interface system 105 also may, in some examples, reside in more than one device.

In some implementations, the control system 110 may be configured to perform, at least in part, the methods disclosed herein. According to some examples, the control system 110 may be configured to receive input audio data and feature weightings. In some examples, the control system 110 may be configured to produce embeddings, based at least in part on the input audio data and the feature weightings. According to some examples, the control system 110 may be configured to apply a contextual encoding process to the embeddings, to produce latent space embeddings in a latent space. In some examples, the control system 110 may be configured to apply a hidden representation process to the latent space embeddings, to produce a representation of the input audio data in the latent space. In some examples, the feature weightings may be, or may include, mask data derived from estimations of signal and noise in the input audio data.

As noted elsewhere herein, the control system 110 may reside in a single device or in multiple devices, depending on the particular implementation. In some examples, all of the foregoing processes may be performed by the same device. In some alternative examples, the foregoing processes may be performed by two or more devices. For example, the embeddings may be produced by one device and the contextual encoding process may be performed by one or more other devices, such as by one or more servers configured to implement a cloud-based service.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 115 shown in FIG. 1A and/or in the control system 110. Accordingly, various innovative aspects of the subject matter described in this disclosure can be implemented in one or more non-transitory media having software stored thereon. The software may, for example, include instructions for controlling at least one device to perform some or all of the methods disclosed herein. The software may, for example, be executable by one or more components of a control system such as the control system 110 of FIG. 1A.

In some examples, the apparatus 100 may include the optional microphone system 120 shown in FIG. 1A. The optional microphone system 120 may include one or more microphones. According to some examples, the optional microphone system 120 may include an array of microphones. In some examples, the array of microphones may be configured to determine direction of arrival (DOA) and/or time of arrival (TOA) information, e.g., according to instructions from the control system 110. The array of microphones may, in some instances, be configured for receive-side beamforming, e.g., according to instructions from the control system 110. In some implementations, one or more of the microphones may be part of, or associated with, another device, such as a speaker of the speaker system, a smart audio device, etc. In some examples, the apparatus 100 may not include a microphone system 120. However, in some such implementations the apparatus 100 may nonetheless be configured to receive microphone data corresponding to one or more microphones in an environment, or corresponding to one or more microphones in another environment, via the interface system 110. In some such implementations, a cloud-based implementation of the apparatus 100 may be configured to receive microphone data, or metadata corresponding to the microphone data, obtained in one or more microphones in an environment via the interface system 110.

According to some implementations, the apparatus 100 may include the optional loudspeaker system 125 shown in FIG. 1A. The optional loudspeaker system 125 may include one or more loudspeakers, which also may be referred to herein as “speakers” or, more generally, as “audio reproduction transducers.” In some examples (e.g., cloud-based implementations), the apparatus 100 may not include a loudspeaker system 125.

In some implementations, the apparatus 100 may include the optional sensor system 130 shown in FIG. 1A. The optional sensor system 130 may include one or more touch sensors, gesture sensors, motion detectors, cameras, eye tracking devices, or combinations thereof. In some implementations, the one or more cameras may include one or more free-standing cameras. In some examples, one or more cameras, eye trackers, etc., of the optional sensor system 130 may reside in a television, a mobile phone, a smart speaker, or combinations thereof. In some examples, the apparatus 100 may not include a sensor system 130. However, in some such implementations the apparatus 100 may nonetheless be configured to receive sensor data for one or more sensors (such as cameras, eye trackers, etc.) residing in or on other devices in an environment via the interface system 110.

In some implementations, the apparatus 100 may include the optional display system 135 shown in FIG. 1A. The optional display system 135 may include one or more displays, such as one or more light-emitting diode (LED) displays. In some instances, the optional display system 135 may include one or more organic light-emitting diode (OLED) displays. In some examples, the optional display system 135 may include one or more displays of a television, a laptop, a mobile device, a smart audio device, or another type of device. In some examples wherein the apparatus 100 includes the display system 135, the sensor system 130 may include a touch sensor system and/or a gesture sensor system proximate one or more displays of the display system 135. According to some such implementations, the control system 110 may be configured for controlling the display system 135 to present one or more graphical user interfaces (GUIs).

According to some such examples the apparatus 100 may be, or may include, a smart audio device, such as a smart speaker. In some such implementations the apparatus 100 may be, or may include, a wakeword detector. For example, the apparatus 100 may be configured to implement (at least in part) a virtual assistant.

FIG. 1B shows an example of an audio signal enhancement chain. As with other figures provided herein, the types, numbers and arrangements of elements shown in FIG. 1B are merely provided by way of example. Other implementations may include more, fewer and/or different types, numbers and arrangements of elements.

According to this example, FIG. 1B shows blocks of an audio signal enhancement chain 150 that are implemented by an instance of the control system 110 that is described with reference to FIG. 1A. As noted elsewhere herein, the control system 110 may, in some instances, reside in more than one device.

In this example, the input audio data 101 is, or may potentially be, contaminated by environmental noise, by one or more interfering noise sources, or combinations thereof. In some examples, the input audio data 101 may be microphone data—in other words, may be microphone signals corresponding to sound captured by one or more microphones—that includes audio signals corresponding to a user's speech.

According to this example, the transform block 102 is configured to convert time domain signals to the frequency domain. The transform block 102 may, for example, be configured to convert time domain signals of the input audio data 101 to frequency bins, such as via a fast Fourier transform.

Preconditioning of input audio signals is an important process for various use cases in which the received audio data is, or may be, contaminated by noise or echo. The pre-conditioning block 104 may be configured to improve the signal-to-noise ratio (SNR) between a target audio signal—such as audio signals of the input audio data 101 corresponding to a user's speech—and interfering audio signals, such as echo or noise. As used herein, the term “echo” refers to sound played back by a loudspeaker in the environment. Accordingly, the pre-conditioning block 104 may provide various types of functionality, depending on the particular implementation. In this example, the pre-conditioning block 104 is configured as an acoustic echo canceller (AEC). In other examples, the pre-conditioning block 104 may be configured for echo suppression, noise suppression, or other audio preconditioning functionality.

In this example, the reference signal 145 is an echo or interfering signal that corresponds to audio being played back by a nearby loudspeaker. According to this example, the reference signal 145 is input to the pre-conditioning block 104 and the mask estimator block 109. In this example, the pre-conditioning block 104 generates a pre-conditioned audio data 106 that is based on the transformed input audio signal 103 and the reference signal 145. According to this example, the pre-conditioning block 104 is configured to generate pre-conditioned audio data 106 that improves the SNR between a target audio signal and echo corresponding to the reference signal 145.

According to this example, the transform block 107 is configured to transform frequency bins of the pre-conditioned audio data 106 into a smaller number of frequency bands of the pre-conditioned audio data 108. In some examples, the transform block 107 may be configured to transform frequency bins of the pre-conditioned audio data 106 into frequency bands of the pre-conditioned audio data 108 that take into account the characteristics of human hearing, such as mel-spaced frequency bands. In other examples, the transform block 107 may be configured to transforms frequency bins of the pre-conditioned audio data 106 into other types of frequency bands, such as logarithmically-spaced frequency bands.

In this example, the mask estimator 109 is configured to output mask data 151 based on the pre-conditioned audio data 108 and the reference signal 145. In some examples, the reference signal 145 input to the mask estimator 109 may be transformed into frequency bands that correspond to those of the pre-conditioned audio data 108, either by the mask estimator 109 itself or by another block of the audio signal enhancement chain 150. The mask data 151 may, for example, be derived from estimations of signal and noise in the input audio data. For example, the mask estimator 109 may be configured to determine the mask data 151 by assigning values to each of a plurality of frequency bands corresponding to the frequency bands of the pre-conditioned audio data 108. The values may indicate which bands of the pre-conditioned audio data 108 are relatively more or relatively less likely to correspond to, or include, a target audio signal such as speech of a user. In other words, the values may indicate which bands of the pre-conditioned audio data 108 are relatively more trustworthy and which bands have been masked by an interfering signal. In this example, the known interfering signal is the reference signal 145. In some such examples, the values may range from 0 and 1, with zero indicating an estimation of 100% noise and 1 indicating an estimation of 100% signal.

According to this example, the suppressor block 160 is configured to attenuate portions—in this example, frequency bands—of the pre-conditioned audio data 108 that the mask data 151 indicates have been contaminated by an interfering signal. In this example, the suppressor block 160 is configured to output corresponding frequency band gains 111 to implement the attenuations determined by the suppressor block 160.

In this example, the inverse transform block 112 is configured to transform the frequency band gains 111 to frequency bin gains 113. According to this example the frequency bins of the frequency bin gains 113 correspond to the frequency bins of the pre-conditioned audio data 106.

According to this example, the multiplication block 114 is configured to apply the frequency bin gains 113 to the pre-conditioned audio data 106 that is output by the pre-conditioning block 104, to produce the frequency-domain output audio data 155. In this example, the inverse transform block 116 is configured to transform the frequency-domain output audio data 155 into the time-domain output audio data 117. According to this example, the time-domain output audio data 117 has a relatively higher SNR than that of the input audio data 101. Therefore, target audio signals, such as audio signals corresponding to a particular person's speech, may be enhanced in the time-domain output audio data 117, as compared to the input audio data 101. (As used herein, the terms “audio data,” “audio signal” and “audio signals” may be used interchangeably. For example, interfering audio data from a single source, such as that corresponding to a second person talking in the environment, may either be referred to in the singular, as an “interfering audio signal,” or in the plural, as “interfering audio signals.”)

However, even after the above-described operations of audio signal enhancement chain 150 have been performed, some level of interfering audio signals will often remain in the time-domain output audio data 117. Due in part to temporal changes of the target audio signals and the interfering audio signals, some portions—for example, some frequency bands—of the target audio signals may be obscured by higher-energy interfering audio signals, while other portions may be unobscured. In some instances, the interfering audio signals may be so loud that suppressing these interfering audio signals causes significant distortion of the target audio signals in the masked portions of target signal. Some aspects of the present disclosure address the above-described issues with previously-deployed methods by implementing what may be referred to herein as a “masquerade” module.

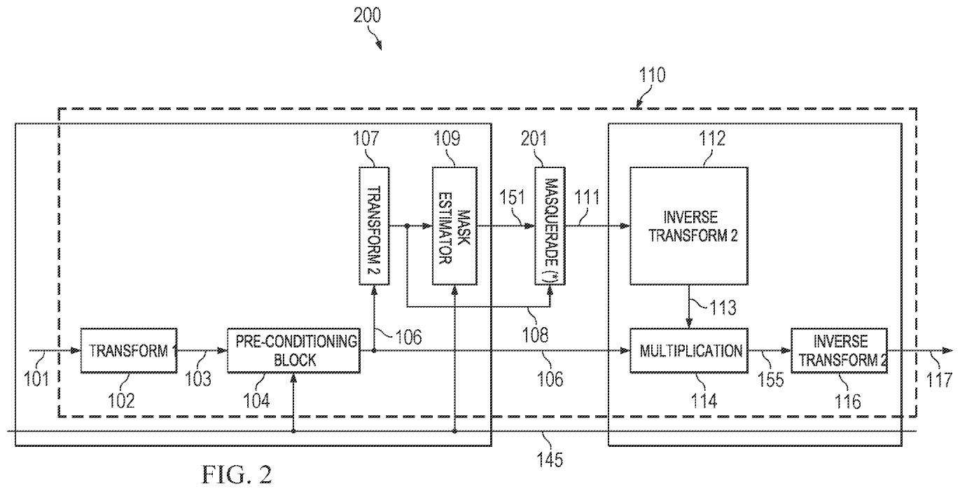

FIG. 2 shows an alternative example of an audio signal enhancement chain according to some disclosed implementations. As with other figures provided herein, the types, numbers and arrangements of elements shown in FIG. 2 are merely provided by way of example. Other implementations may include more, fewer and/or different types, numbers and arrangements of elements.

According to this example, FIG. 2 shows blocks of an audio signal enhancement chain 200 that are implemented by an instance of the control system 110 that is described with reference to FIG. 1A. As noted elsewhere herein, the control system 110 may, in some instances, reside in more than one device.

In this example, elements 101, 102, 103, 104, 106, 107, 108, 109, 111, 112, 113, 114, 116, 117, 145, 150 and 155 may be as described above with reference to FIG. 1B, except as noted in the description of FIG. 2. Accordingly, the descriptions of elements 101, 102, 103, 104, 106, 107, 108, 109, 111, 112, 113, 114, 116, 117, 145, 150 and 155 will not be repeated here.

However, the example shown in FIG. 2 includes the newly-disclosed masquerade module 201. The masquerade module 201 may, in some examples, be configured to use SRL and mask information to extract information about the target signal from those portions that are not masked, or are only slightly masked, to ensure that after processing the interfering signal is suppressed only by the correct amount to result in a less distorted result.

In this example, the process of estimating the energy of the interfering signal—for example, by the mask estimator 109 or by a similar block—may be substantially as described with reference to FIG. 1B. The corresponding feature weightings—which are mask data in this example—may inform the masquerade module 201 about which portions of the pre-conditioned audio data 108 are most likely to correspond to target signals when determining a representation of the partially masked underlying target signal.

More broadly, the masquerade module 201 may, in some examples, be configured to produce embeddings, based at least in part on input audio data and feature weightings. The input audio data may, in some examples, be preconditioned audio data, such as the pre-conditioned audio data 108 of FIGS. 1B and 2. However, in some examples the input audio data may not have been preconditioned. The feature weightings may, in some examples, be mask data output by the mask estimator 109 or by a similar block. The mask data may be derived from estimations of signal and noise in the input audio data. The embeddings may correspond with unmasked portions of the input audio data.

According to some examples, the masquerade module 201 may be configured to apply a contextual encoding process to the embeddings, to produce latent space embeddings in a latent space. The contextual encoding process may, in some examples, be performed by a neural network implemented by the control system 110 of FIG. 2. In some examples, the masquerade module 201 may be configured to apply a hidden representation process to the latent space embeddings, to produce a representation of the input audio data in the latent space.

In some examples, the masquerade module 201 may be configured to apply a contextual decoding process to the representation of the input audio data in the latent space, to produce a modified audio signal, or to produce output from which a modified audio signal may be produced. Examples of output from which a modified audio signal may be produced are the frequency band gains 111 produced by the masquerade module 201 in the example of FIG. 2. Accordingly, in this example the output of the masquerade module 201 is, or includes, output from which a modified audio signal may be produced. In alternative examples, the output of the masquerade module 201 may be, or may include, a modified audio signal.

The masquerade module 201 may, in some examples, be trained on audio signals that have been masked. In some instances, the masquerade module 201 may be trained on synthesized masks. According to some examples, the masks may have been synthesized independently of target application, such as echo suppression or noise suppression. In some examples, the masquerade module 201 may be trained to be robust against a variety of errors in the mask estimation. Thus trained, the masquerade module 201 may be used to unmask the underlying target signal based on information from a variety of classical signal processing or neural-network-based methods for interferer estimation and used for applications such as—but not limited to—echo suppression, noise suppression, beamforming and source separation. The masquerade module 201 may, in some examples, be used in a signal processing chain that derives a mask estimate from a combination of two or more such use cases.

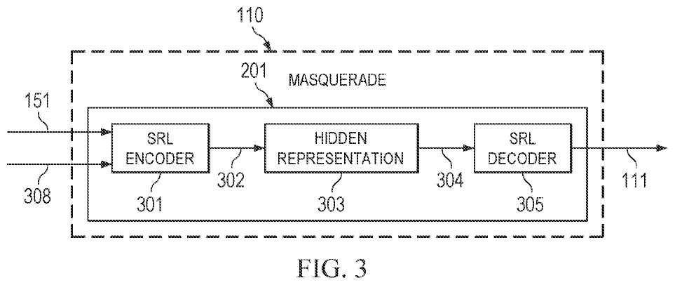

FIG. 3 shows example blocks of a masquerade module according to some disclosed implementations. As with other figures provided herein, the types, numbers and arrangements of elements shown in FIG. 3 are merely provided by way of example. Other implementations may include more, fewer and/or different types, numbers and arrangements of elements. For example, in some alternative implementations the masquerade module 201 may include blocks 301 and 303, but not block 305. In some such implementations, another block of an audio signal processing chain may include block 305.

According to this example, the masquerade module 201 includes the following elements:
301: A speech representation learning (SRL) encoder block that is configured to map the contaminated input audio data 308 and the mask data 151 to a high-level representation of the audio which is domain independent and robust to acoustic interference;
302: The outputs of different layers of the SRL encoder block 301, which may be referred to as latent space embeddings 302. In some examples, the SRL encoder block 301 may be implemented by a neural network. In some such examples, different latent space embeddings 302 may be output from different layers of the neural network;
303: A hidden representation block that is configured to use latent space embeddings 302 to build a high-level representation 304 of the input audio data 308 in the latent space;
304: The high-level representation or codes of the input audio data 308;
305: A speech representation learning (SRL) decoder block that is configured to transform the high-level representation 304 to the domain of the contaminated input audio data 308 in order to enhance the contaminated input audio data 308;
111: an enhanced audio signal, or data from which an enhanced audio signal may be constructed from the contaminated input audio data 308, depending on the particular implementation.

In some examples, the hidden representation block 303 may apply a consolidation process, such as a pooling process, to multiple latent space embeddings 302 to produce a single high-level representation 304. In some examples, the hidden representation block 303 may produce a high-level representation 304 that is a lower-dimension representation of multiple latent space embeddings 302. According to some examples, the hidden representation block 303 may produce a single high-level representation 304 according to one or more averaging processes. In some examples, the hidden representation block 303 may implement one or more attention-based averaging processes. In some such examples, the hidden representation block 303 may produce a single high-level representation 304 according to at least one time-based averaging process, such as a process that operates on latent space embeddings 302 that correspond to multiple frames of input data.

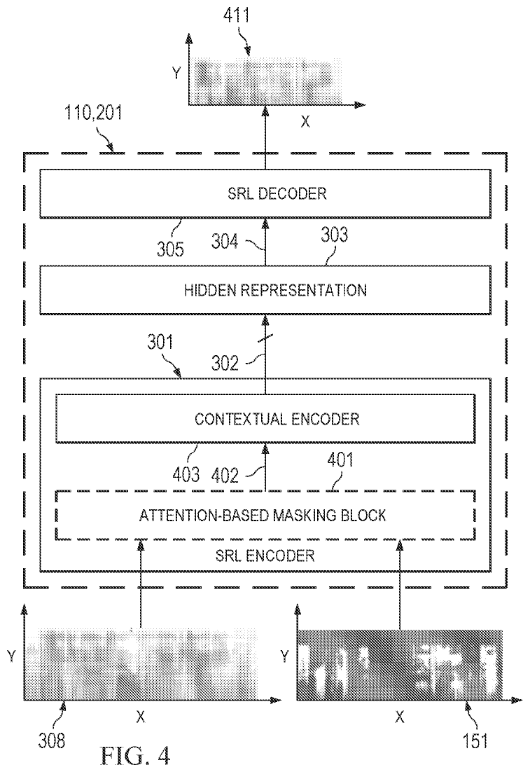

FIG. 4 shows example blocks of a masquerade module according to some alternative implementations. As with other figures provided herein, the types, numbers and arrangements of elements shown in FIG. 4 are merely provided by way of example. Other implementations may include more, fewer and/or different types, numbers and arrangements of elements. For example, in some alternative implementations the masquerade module 201 may include blocks 301 and 303, but not block 305. In some such implementations, another block of an audio signal processing chain may include block 305. According to some alternative implementations, the masquerade module 201 may not include the optional attention-based masking block 401.

In this example, the masquerade module 201 is implemented by an instance of the control system 110 of FIG. 1A. According to this example, the masquerade module 201 includes examples of the SRL encoder block 301, the hidden representation block 303 and the SRL decoder block 305 that are described with reference to FIG. 3. Unless the description of FIG. 4 indicates otherwise, the hidden representation block 303 and the SRL decoder block 305 may function as described with reference to FIG. 3. FIG. 4 shows additional details of the SRL encoder block 301 according to one example.

According to this example, the masquerade module 201 is shown outputting target audio data 411, which is a “clean” version of the the contaminated input audio data 308. In the examples shown in FIG. 4, the y axes of the graphs associated with the mask data 151, the contaminated input audio data 308 and the target audio data 411 indicate frequency and the x axes indicate time. The graph associated with the target audio data 411 indicates “clean,” uncontaminated audio signals, which correspond a particular person's speech in this example. The graph associated with the contaminated input audio data 308 indicates a combination of uncontaminated audio signals and interfering audio signals, which are audio signals corresponding to another person's speech, in this example. In other examples, the interfering audio signals may correspond to audio data being played back by a nearby loudspeaker, or to some other type(s) of interfering audio signal(s). In the graph associated with the mask data 151, the white areas indicate noise. According to this example, the mask data 151 is derived from estimations of signal (uncontaminated audio signals) and noise (interfering audio signals) in the contaminated input audio data 308. Accordingly, the white areas of the mask data 151 correspond with the interfering audio signals of the contaminated input audio data 308.

In this example, the SRL encoder block 301 includes an optional attention-based masking block 401 and a contextual encoder 403. In some examples, the control system 110 includes a neural network has been trained to implement the contextual encoder 403. The neural network may, for example, be a transformer neural network or a conformer neural network. Alternatively, or additionally, the control system 110 may include a neural network has been trained to implement the attention-based masking block 401.

According to this example, the attention-based masking block 401 is configured for producing embeddings 402, based at least in part on the contaminated input audio data 308 and feature weightings. In this example, the feature weightings are the mask data 151.

In this example, the attention-based masking block 401 is configured to produce the embeddings 402 according to an attention-based masking process that is informed by the mask data 151. In some such examples, the attention-based masking block 401 may be configured to produce the embeddings 402 by paying relatively less attention to regions of the contaminated input audio data 308 that the mask data 151 indicates to include noise and relatively more attention to regions of the contaminated input audio data 308 that the mask data 151 indicates to include signal. In some such examples, the attention-based masking block 401 may be, or may include, a convolutional neural network (CNN) that computes a weighted convolution. The weighted convolution may, in some examples, be weighted by the incoming masks. The weighted convolution may, in some examples, produce weights associated with the outputs at each layer of a neural network that is implementing the attention-based masking block 401. The mask data 151 may, for example, indicate values assigned to each of a plurality of frequency bands corresponding to the frequency bands of the contaminated input audio data 308. The values may indicate which bands of the contaminated input audio data 308 are relatively more or relatively less likely to correspond to the target audio signal 411. In some such examples, the values may range from 0 and 1, with zero indicating an estimation of 100% noise and 1 indicating an estimation of 100% signal.

In some examples, the embeddings 402 may be, or may include mathematical representations of portions of the input audio data—for example, those portions that are estimated to correspond to the target audio data 411—in an embedding space that is different from the mathematical space of the input audio data. In this example, the embedding space may be different from the time/frequency space of the contaminated input audio data 308 and the target audio data 411. In some examples, the embedding space may include more dimensions than the mathematical space of the input audio data or of the target audio data. In some examples, the input audio data may be represented by energies in multiple frequency bands, such as 16, 30, 32, 40, 48, 50, 64, 80, 100 or 128 frequency bands. In some examples, the frequency bands may be Mel or log-spaced frequency bands. According to some such examples, the embedding space may be configured to produce embedding in a latent space that includes 256 dimensions, 512 dimensions, 768 dimensions, etc.

In this example, the contextual encoder 403 is configured to produce the latent space embeddings 302. In some examples, different latent space embeddings 302 may be output from different layers of a neural network that implements the contextual encoder 403.

In this example, the input audio data (the contaminated input audio data 308) has not been pre-conditioned. However, in some alternative examples the input audio data may have been pre-conditioned according to one or more audio data processing methods, such as an echo cancellation process, an echo suppression process, a noise suppression process, a beamforming process, or combinations thereof.

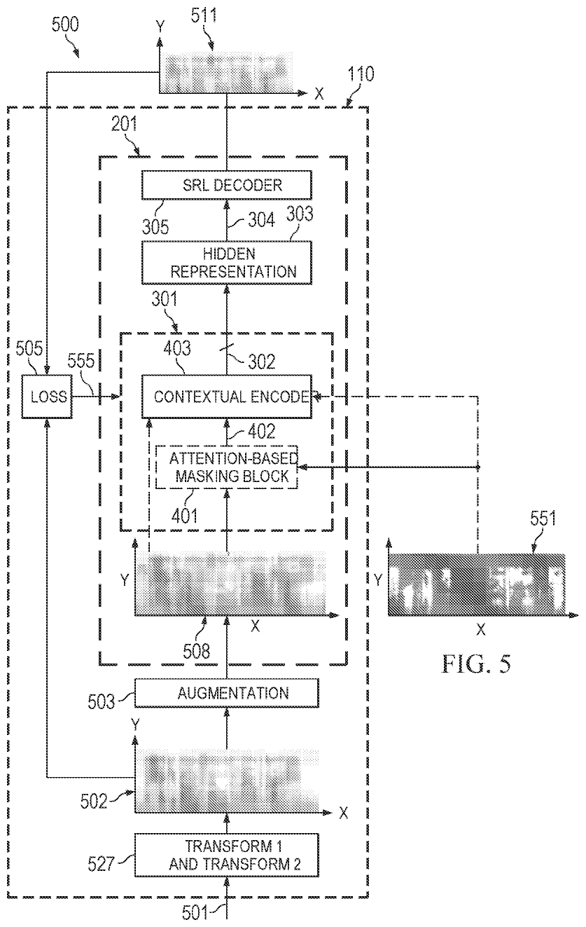

FIG. 5 shows example blocks of a process of training a masquerade module according to some implementations. As with other figures provided herein, the types, numbers and arrangements of elements shown in FIG. 5 are merely provided by way of example. Other implementations may include more, fewer and/or different types, numbers and arrangements of elements. For example, in some alternative implementations the masquerade module 201 may include blocks 301 and 303, but not block 305. According to some implementations, the masquerade module 201 may not include the optional attention-based masking block 401.

In this example, the transform blocks 102 and 107, the augmentation block 503, the loss function module 505 and the masquerade module 201 are implemented by an instance of the control system 110 of FIG. 1A. According to this example, the masquerade module 201 includes examples of the SRL encoder block 301, the hidden representation block 303 and the SRL decoder block 305 that are described with reference to FIGS. 3 and 4.

According to this example, the clean time domain signal 501 is transformed by the transform block 527 into real and imaginary frequency components. The transform block 527 converts these frequency components to the band power spectral domain, to produce the transformed clean input audio signal 502. In this example, the transform block 527 includes the functionality of transform blocks 102 and 107 of FIG. 1B.

In this example, the SRL encoder block 301 includes an optional attention-based masking block 401 and a contextual encoder 403. In this example, the control system 110 includes a neural network that is being trained to implement the contextual encoder 403. The neural network may, for example, be a transformer neural network or a conformer neural network. According to this example, the control system 110 includes a neural network that is being trained to implement the attention-based masking block 401.

According to this example, the SRL encoder block 301 is being trained according to mask data 551 and according to contaminated audio signals 508 that are output from an audio augmentation process that is implemented by the augmentation block 503. The audio augmentation process may, for example, involve adding noise, adding reverberations, adding audio signals corresponding to speech, adding audio signals corresponding to other interfering audio sources, or combinations thereof, to the transformed clean input audio signal 502. The graph associated with the contaminated audio signals 508 indicates both clean signals corresponding to a person's speech and interfering audio signals, which are audio signals corresponding to another person's speech in this example. The white portions of the mask data 551 are estimates of the interfering audio signal portions of the contaminated audio signals 508.

In this example, the contaminated audio signals 508 and the mask data 551 are provided to the optional attention-based masking block 401. Here, the optional attention-based masking block 401 is configured to produce the embeddings 402 according to an attention-based masking process, which may be performed as described with reference to FIG. 4. In alternative examples which do not include the optional attention-based masking block 401, the contaminated audio signals 508 and the mask data 551 may be provided directly to the contextual encoder 403, or may be provided to an intermediate block that produces embeddings that are input to the contextual encoder 403.

According to this example, the masquerade module 201 produces a predicted target signal 511 during the training process, which is provided to the loss function module 505. In this example, the loss function module 505 is configured to determine a loss function gradient 555 based on the predicted target signal 511 and the transformed clean input audio signal 502. According to some examples, the loss function module 505 may be configured to implement a loss function that is based on the negative of a measure of similarity between the predicted target signal 511 and the transformed clean input audio signal 502. According to this example, the control system 110 is configured to update parameters of the masquerade module 201 according to the loss function gradient 555 until one or more convergence metrics are attained. In some examples, the control system 110 may be configured to determine that convergence has been attained when the training process for the masquerade module 201 achieves a state in which the loss determined by the loss function settles to within an error range around a final value, or a state in which a difference between the predicted target signal 511 and the transformed clean input audio signal 502 is no longer decreasing, or in which the difference does not decrease for a predetermined number of steps or epochs.

According to some examples, training the SRL encoder block 301 may involve modulating mask data parameters of the mask data 551. In some such examples, one or more other types of data used in, or aspects of, the training process may be held constant while mask data parameters of the mask data 551 are modulated. For example, the transformed clean input audio signal 502 may be held constant while mask data parameters of the mask data 551 are modulated. Alternatively, or additionally, the augmentation process implemented by the augmentation block 503 may be held constant while mask data parameters of the mask data 551 are modulated. In some examples, the SRL encoder block 301 may be trained to recognize and to compensate for one or more errors in the masking process.

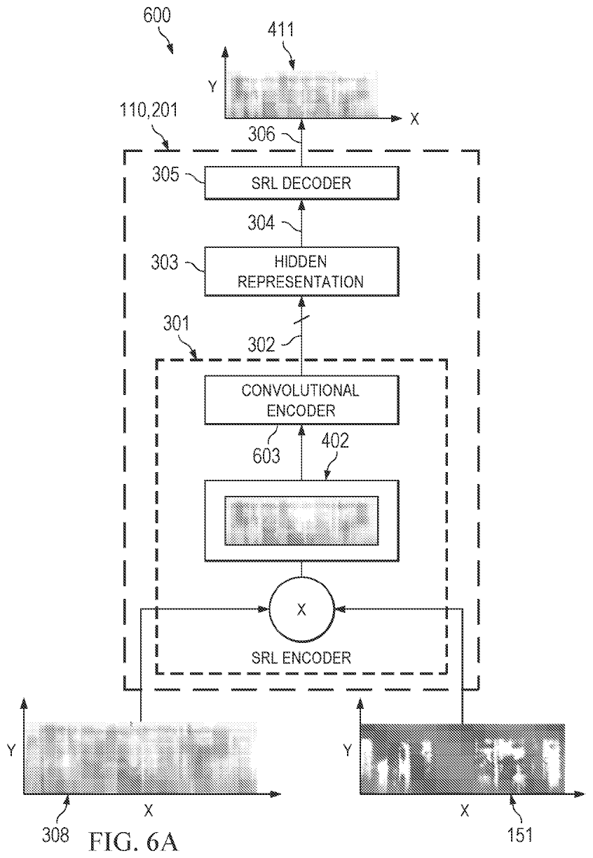

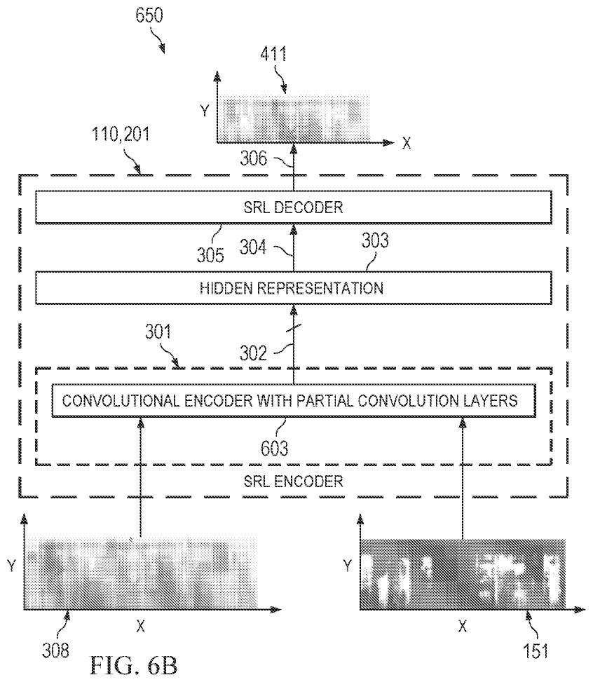

FIGS. 6A and 6B show example blocks of masquerade modules according to some alternative implementations. As with other figures provided herein, the types, numbers and arrangements of elements shown in FIGS. 6A and 6B are merely provided by way of example. Other implementations may include more, fewer and/or different types, numbers and arrangements of elements. In these examples, each of the masquerade modules 201 is implemented by an instance of the control system 110 of FIG. 1A. According to these examples, the masquerade module 201 includes examples of the SRL encoder block 301, the hidden representation block 303 and the SRL decoder block 305 that are described with reference to FIG. 3. Unless the description of FIG. 4 indicates otherwise, the hidden representation block 303 and the SRL decoder block 305 may function as described with reference to FIG. 3.

In these examples, the input audio data (the contaminated input audio data 308) has not been pre-conditioned. However, in some alternative examples the input audio data may have been pre-conditioned according to one or more audio data processing methods, such as an echo cancellation process, an echo suppression process, a noise suppression process, a beamforming process, or combinations thereof.

According to these examples, each of the masquerade modules 201 is shown outputting target audio data 411, which is a “clean” version of the the contaminated input audio data 308. In these examples, the y axes of the graphs associated with the mask data 151, the contaminated input audio data 308 and the target audio data 411 indicate frequency and the x axes indicate time. In the graphs associated with the mask data 151, the contaminated input audio data 308 and the target audio data 411, the blue areas correspond to “clean,” uncontaminated audio signals, which correspond a particular person's speech in these examples. The graphs associated with the contaminated input audio data 308 indicate both uncontaminated audio signals and interfering audio signals, the latter of which are audio signals corresponding to another person's speech. In other examples, the interfering audio signals may correspond to some other type(s) of interfering audio signal(s). In the graphs associated with the mask data 151, the white areas indicate estimates of the interfering audio signals. According to these examples, the mask data 151 are derived from estimations of signal and noise in the contaminated input audio data 308. As in the example shown in FIG. 4, the white areas of the mask data 151 correspond with the interfering audio signals of the contaminated input audio data 308.

In the example shown in FIG. 6A, the SRL encoder block 301 is configured to produce embeddings 402 based on the contaminated input audio data 308 and based on feature weightings, which are the mask data 151 in this example. According to this example, the SRL encoder block 301 is configured to compute a dot product of the contaminated input audio data 308 and the mask data 151 to produce the embeddings 402. In this example, the embeddings 402 are new audio signals in which the energy in the portions to be ignored—according to the mask data 151—has been silenced. Therefore, in this example the embeddings 402 include mathematical representations of portions of the input audio data in an embedding space that is the same as the mathematical space of the contaminated input audio data 308.

In this example, the control system 110 includes a neural network has been trained to implement the convolutional encoder 603. According to this example, the convolutional encoder 603 is configured to produce the latent space embeddings 302. In this example, the convolutional encoder 603 has been trained to identify the masked or silent portions of the embeddings 402 and to generate representations of new audio data—the latent space embeddings 302—corresponding to the masked portions. In some examples, different latent space embeddings 302 may be output from different layers of a neural network that implements the convolutional encoder 603.

In some examples, the convolutional encoder 603 is configured to produce the latent space embeddings 302 in an embedding space that is different from the mathematical space of the embeddings 402. In some examples, the embedding space may be a higher-dimensional space than the mathematical space of the embeddings 402.

In the example shown in FIG. 6B, the SRL encoder block 301 includes a version of the convolutional encoder 603 that includes partial convolution layers. According to this example, the audio data where the mask is zero is not included in each convolution step implemented by the convolutional encoder 603 and the convolution calculation is scaled according to the number of inputs. In this example, the mask passed to the subsequent convolution layer is updated such that the “holes” corresponding to the masked audio data shrink at each subsequent convolution layer.

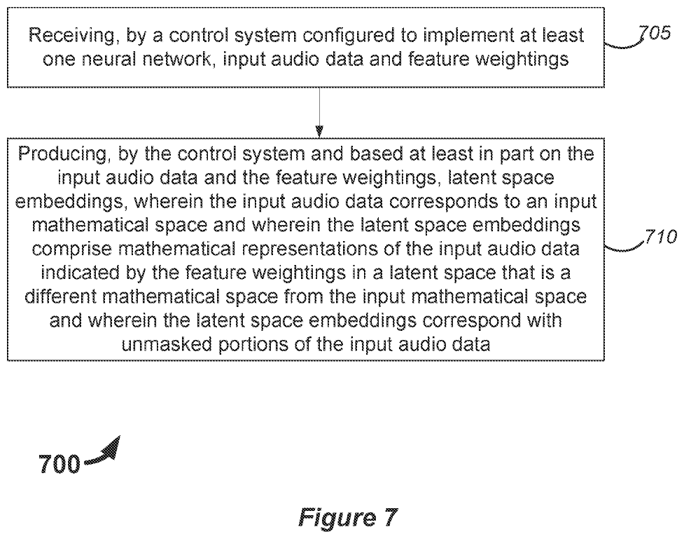

FIG. 7 is a flow diagram that outlines one example of a disclosed method. The blocks of method 700, like other methods described herein, are not necessarily performed in the order indicated. According to some examples, one or more blocks may be performed in parallel. Moreover, some similar methods may include more or fewer blocks than shown and/or described.

The method 700 may be performed by an apparatus or system, such as the apparatus 100 that is shown in FIG. 1A and described above. In some examples, the apparatus 100 includes at least the control system 110 disclosed herein. In some examples, at least some aspects of method 700 may be performed by one or more devices within an audio environment, e.g., by an audio system controller (such as what may be referred to herein as a smart home hub) or by another component of an audio system, such as a television, a television control module, a laptop computer, a mobile device (such as a cellular telephone), etc. However, in some implementations at least some blocks of the method 700 may be performed by one or more devices that are configured to implement a cloud-based service, such as one or more servers.

In this example, block 705 involves receiving, by a control system configured to implement at least one neural network, input audio data and feature weightings. In some examples, the input audio data may include audio signals corresponding to speech. In some examples, the feature weightings may be, or may include, mask data. The mask data may, for example, be derived from estimations of signal and noise in the input audio data.

According to this example, block 710 involves producing, by the control system and based at least in part on the input audio data and the feature weightings, latent space embeddings. In this example, the input audio data may correspond to an input mathematical space, such as a time/frequency space. In this example, the latent space embeddings are, or include, mathematical representations of the input audio data in a latent space that is a different mathematical space from the input mathematical space, such as a higher-dimension mathematical space. According to this example, the latent space embeddings correspond with unmasked portions of the input audio data.

In some examples, the control system may be configured to implement a convolutional neural network that is configured to perform weighted convolution. In some such examples, method 700 may involve performing a weighted convolution that is based, at least in part, on the feature weightings.

According to some examples, the input audio data and the feature weightings may correspond to frequency bands.

In some examples, the input audio data may have been pre-conditioned according to one or more audio data processing methods, such as an echo cancellation process, an echo suppression process, a noise suppression process, a beamforming process, or combinations thereof.

According to some examples, producing the latent space embeddings may involve applying, by the control system, a contextual encoding process. In some such examples, the at least one neural network may have been trained to implement the contextual encoding process.

Method 700 may, in some examples, involve applying, by the control system, a contextual decoding process to the representation of the input audio data in the latent space, to produce a modified audio signal. Alternatively, or additionally, method 700 may involve applying the contextual decoding process to the representation of the input audio data in the latent space to produce output data from which a modified audio signal may be produced, such as the frequency band gains 111 that are described with reference to FIG. 2. Method 700 may, in some examples, involve producing a residual signal based, at least in part, on the modified audio signal and a version of the input audio data. The version of the input audio data may be, or may include, frequency binned audio data in some instances. According to some examples, the modified audio signal may be in a frequency domain. Producing the residual signal may involve transforming a frequency domain version of the residual signal into the time domain.

In some examples method 700 may involve applying, to the latent space embeddings and by the control system, a hidden representation process. The hidden representation process may produce a representation of the input audio data in the latent space.

According to some examples, the control system may be configured to implement at least one neural network that has been trained to implement an attention-based masking process. In some examples, method 700 may involve producing embeddings according to an attention-based masking process.

In some examples, the at least one neural network may have been trained according to mask data and according to contaminated audio signals output from an audio augmentation process. The audio augmentation process may involve adding noise, adding reverberations, adding audio signals corresponding to speech or other interfering audio sources, or combinations thereof.

According to some examples, training the at least one neural network may involve modulating mask data parameters. In some examples, training the at least one neural network may involve maintaining a constant target audio signal during one or more time intervals during which the mask data parameters are modulated. In some examples, an attention-based masking process, a contextual encoding process, or both, may have been trained to recognize and to compensate for one or more errors in the masking process.

In some examples, the control system may be configured for speech representation learning (SRL). In some such examples, the at least one neural network may include an SRL encoder. The SRL encoder may, in some instances, include, or be, a convolutional encoder. According to some examples, the convolutional encoder may include partial convolution layers.

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1. A method, comprising:
receiving, by a control system configured to implement at least one neural network, input audio data and feature weightings;
producing, by the control system and based at least in part on the input audio data and the feature weightings, latent space embeddings, wherein the input audio data corresponds to an input mathematical space and wherein the latent space embeddings comprise mathematical representations of the input audio data indicated by the feature weightings in a latent space that is a different mathematical space from the input mathematical space and wherein the latent space embeddings correspond with unmasked portions of the input audio data; and
constructing, by the control system, a modified audio signal based on the latent space embeddings.

2. The method of claim 1, wherein the feature weightings comprise mask data.

3. The method of claim 1, wherein the mask data is derived from estimations of signal and noise in the input audio data.

4. The method of claim 1, wherein the control system is configured to implement a convolutional neural network configured to perform weighted convolution and wherein the weighted convolution is based, at least in part, on the feature weightings.

5. The method of claim 1, wherein producing the latent space embeddings involves applying, by the control system, a contextual encoding process.

6. The method of claim 5, wherein the at least one neural network has been trained to implement the contextual encoding process.

7. The method of claim 1, further comprising applying, to the latent space embeddings and by the control system, a hidden representation process, to produce a representation of the input audio data in the latent space.

8. The method of claim 7, further comprising applying, by the control system, a contextual decoding process to the representation of the input audio data in the latent space, to produce the modified audio signal.

9. The method of claim 8, further comprising producing a residual signal based, at least in part, on the modified audio signal and a version of the input audio data.

10. The method of claim 9, wherein the version of the input audio data comprises frequency binned audio data.

11. The method of claim 9, wherein the modified audio signal is in a frequency domain and wherein producing the residual signal involves transforming a frequency domain version of the residual signal into a time domain.

12. The method of claim 1, wherein the input audio data and the feature weightings correspond to frequency bands.

13. The method of claim 1, wherein the input audio data has been pre-conditioned according to one or more audio data processing methods.

14. The method of claim 13, wherein the input audio data has been pre-conditioned according to at least one of an echo cancellation process, an echo suppression process, a noise suppression process or a beamforming process.

15. The method of claim 1, wherein the at least one neural network has also been trained to implement an attention-based masking process for producing embeddings.

16. The method of claim 15, wherein at least one of the attention-based masking process or a contextual encoding process has been trained to recognize and to compensate for one or more errors in the masking process.

17. The method of claim 15, wherein the at least one neural network has been trained according to mask data and according to contaminated audio signals output from an audio augmentation process.

18. The method of claim 17, wherein the audio augmentation process involves adding noise, adding reverberations, adding audio signals corresponding to speech or other interfering audio sources, or combinations thereof.

19-21. (canceled)

22. The method of any claim 1, wherein the control system is configured for speech representation learning (SRL).

23. The method of claim 22, wherein the at least one neural network includes an SRL encoder.

24. The method of claim 23, wherein the SRL encoder comprises a convolutional encoder.

25. The method of claim 23, wherein the convolutional encoder includes partial convolution layers.

26. An apparatus comprising:
a control system configured to:
receiving receive input audio data and feature weightings;
produce space embeddings, wherein the input audio data corresponds to an input mathematical space and wherein the latent space embeddings comprise mathematical representations of the input audio data indicated by the feature weightings in a latent space that is a different mathematical space from the input mathematical space and wherein the latent space embeddings correspond with unmasked portions of the input audio data; and
construct a modified audio signal based on the latent space embeddings.

27. (canceled)
